(19) United States
(12) Patent Application Publication
(10) Pub. No.: US 2010/0013992 A1
(43) Pub. Date: Jan. 21, 2010

(54) METHOD AND SYSTEM FOR DETECTING MOTION AT AN INTERMEDIATE POSITION BETWEEN IMAGE FIELDS

(76) Inventors: Zhi Zhou, Corona, CA (US); Yeong-Taeg Kim, Irvine, CA (US)

Correspondence Address: Myers Andras Sherman LLP, 19900 MacArthur Blvd., Suite 1150, Irvine, CA, 92612, US

(21) Appl. No.: 12/176,234

(22) Filed: Jul. 18, 2008

(51) Int. Cl. H04N 7/01

(52) U.S. Cl. 348/459; 348/E07.003

(57) ABSTRACT

A method and system for detecting motion at a temporal intermediate position between image fields is provided. One implementation involves detecting an uncovering area in the temporal intermediate position in an image field; determining a motion vector candidate, in place of a current original motion vector, for the temporal intermediate position with a detected uncovering area; and determining a motion vector representing motion at the temporal intermediate position by combining the candidate motion vector with a current original motion vector for the temporal intermediate position. Erroneous motion vectors in uncovering areas are eliminated.

### FIELD OF THE INVENTION

The present invention relates generally to video signal processing and in particular to motion vector processing for video frames.

### BACKGROUND OF THE INVENTION

In block-based motion estimation for a sequence of video frames, a current input video frame is divided into small blocks. For each block in the current frame, an attempt is made to find a best matching block within a search area of a previous frame, based on certain criteria such as minimum Sum of Absolute Difference (SAD) values. The translation between blocks in the current frame and a corresponding best matching block in a previous frame is denoted as a motion vector (MV).

The obtained motion vectors can be widely used in motion compensation algorithms for video signal processing, such as compression, noise reduction, frame rate conversion, etc. The more accurate the motion vectors, the better the performance of motion compensation.

However, for a block in an uncovering area of a current frame, there is no actual matching block available in a previous frame. As a result, conventional motion vector estimation methods typically generate an erroneous motion vector, as an outlier in the motion field. In motion compensated frame rate conversion (FRC) and motion judder cancellation (MJC), the motion field normally is obtained by using block-matching motion estimation. An erroneous motion vector in an uncovering area leads to blockiness and halo effects in FRC/MJC video output results.

### BRIEF SUMMARY OF THE INVENTION

The present invention provides a method and system for detecting motion at a temporal intermediate position between image fields. One embodiment involves detecting an uncovering area in the temporal intermediate position in an image field; determining a motion vector candidate, in place of a current original motion vector, for the temporal intermediate position with a detected uncovering area; and determining a motion vector representing motion at the temporal intermediate position by combining the candidate motion vector with a current original motion vector for the temporal intermediate position. Erroneous motion vectors in uncovering areas are eliminated.

These and other features, aspects and advantages of the present invention will become understood with reference to the following description, appended claims and accompanying figures.

### BRIEF DESCRIPTION OF THE DRAWINGS

FIG. 1 shows an example motion vector calculation, according to an embodiment of the invention.

FIG. 2 shows a functional block diagram of a system for determining motion vectors for uncovering frame areas, according to an embodiment of the invention.

FIG. 3 shows a process for determining motion vectors for uncovering frame areas, according to an embodiment of the invention.

FIG. 4 shows processing of motion vectors for an uncovering frame area, according to an embodiment of the invention.

### DETAILED DESCRIPTION OF THE INVENTION

The present invention provides a method and system for detecting motion at a temporal intermediate position between image fields. One embodiment involve involves eliminating erroneous motion vectors by filtering motion vectors in uncovering areas.

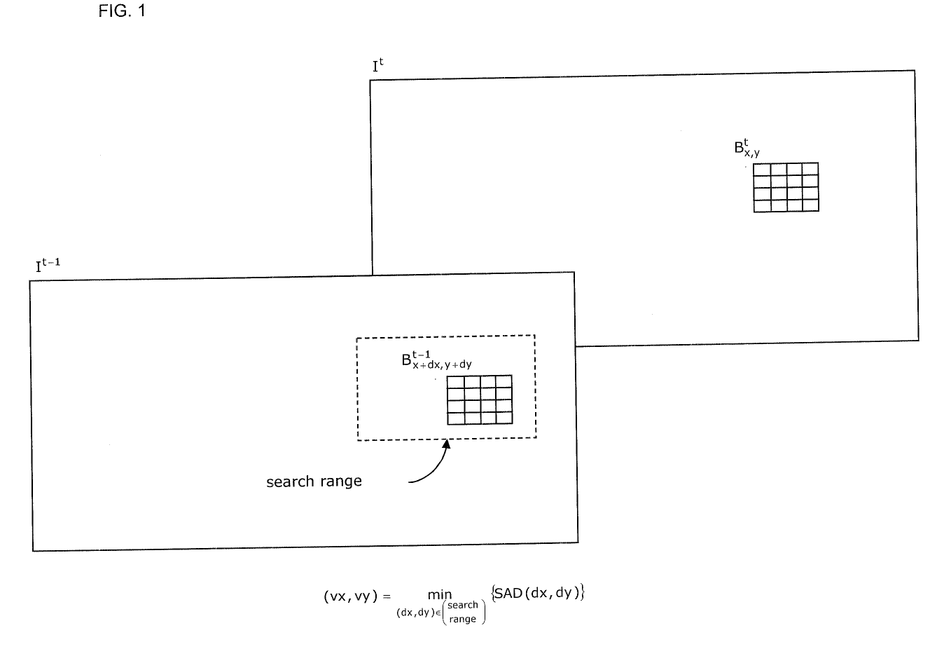

FIG. 1 illustrates example block-matching based motion estimation. If B_{x,y}^{t} represents a block at location (x, y) in the current frame I^{t} of size m×n pixels, and B_{x+dx,y+dy}^{t-1} represents a block displaced from location (x, y) by (dx, dy) in the previous frame I^{t-1} (also of size m×n pixels), then the SAD between the two blocks for the motion vector (dx, dy) is given by the expression:

$$SAD ( dx , dy ) = {\sum }_{i = 0}^{m - 1} {\sum }_{j = 0}^{n - 1} \vert {B}_{x , y}^{t} ( i , j ) - {B}_{x + dx , y + dy}^{t - 1} ( i , j ) \vert$$

where B_{x,y}^{t} (i, j) represents pixel (i, j) within the block (with this representation, location (0, 0) within the block refers to the block starting position of (x, y)).

Eliminating erroneous motion vectors involves detecting an uncovering area in the temporal intermediate position in an image field; determining a motion vector candidate, in place of a current original motion vector (i.e., motion vector output from motion estimation, directly without any change), for the temporal intermediate position with a detected uncovering area; and determining a motion vector representing motion at the temporal intermediate position by combining the candidate motion vector with a current original motion vector for the temporal intermediate position. Erroneous motion vectors in uncovering areas are eliminated.

Obtaining a motion vector representing motion at the temporal intermediate position may further include determining said current original motion vector, and combining the candidate motion vector with the current original motion vector. Detecting an uncovering area in the temporal intermediate position in a image field, comprises estimating the average horizontal motion vector on both left and right sides of the temporal intermediate position in the image field, and if the average motion vector of the left side is greater than the average motion vector of the right side, then the temporal intermediate position is an uncovering area.

Determining a motion vector candidate for the temporal intermediate position includes averaging said average motion vectors of both left and right sides of the temporal intermediate position to obtain the motion vector candidate. Combining the candidate motion vector with the current original motion vector comprises combining the candidate motion vector with the current original motion vector based on the absolute difference of the average motion vector of the left side and the average motion vector of the right side.

Combining the candidate motion vector with the current original motion vector comprises combining the candidate motion vector with the current original motion vector based on the smoothness of either the average motion vector of the right side or average motion vector of the left side. In addition, combining the candidate motion vector with the current original motion vector comprises combining the candidate motion vector with the current original motion vector based on the minimum distance from the original motion vector to the average motion vector of the right side and the average motion vector of the left side. Or, combining the candidate motion vector with the current original motion vector can comprise combining the candidate motion vector with the current original motion vector based on the direction of the original motion vector relative to the average motion vector of the right side and/or the average motion vector of the left side.

An example implementation involves eliminating such erroneous motion vectors by filtering motion vectors in uncovering areas. The uncovering area and erroneous motion vectors are detected and the erroneous motion vectors are corrected. This involves scanning the motion field to detect the uncovering area, then applying motion vector filtering on the blocks in the uncovering area. Then the filtered motion vectors are combined (mixed) with the original motion vectors based on certain criteria. This removes motion vector outliers in uncovering areas.

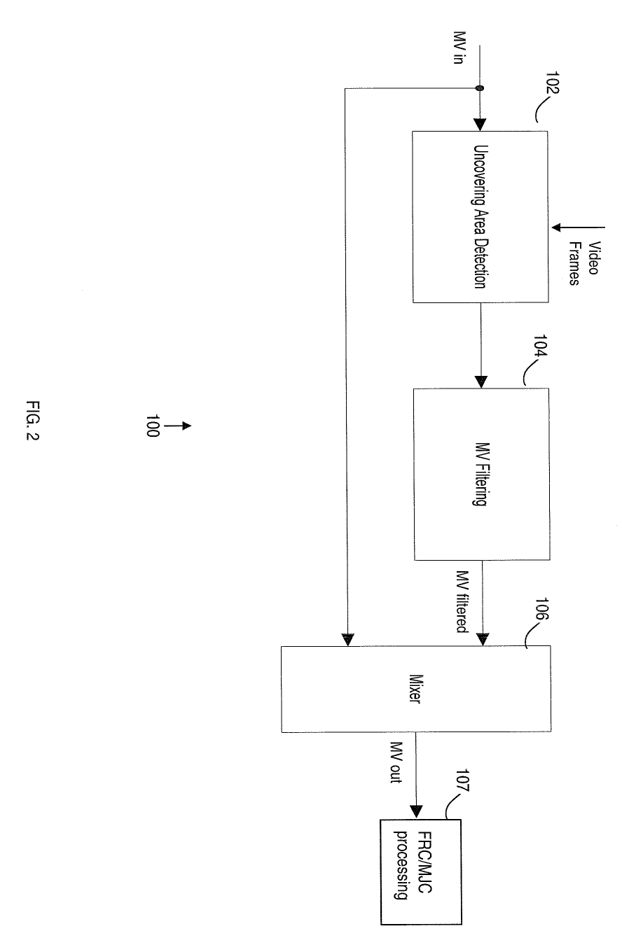

FIG. 2 shows a functional block diagram of a system 100 for filtering erroneous motion vectors in uncovering areas. The system 100 includes an uncovering area detection module 102, a motion vector (MV) filtering module 104 and a combiner (mixer) module 106. The uncovering area detection module 102 detects uncovering area in a current video frame. Then, the MV filtering module 104 filters the motion vectors of only the blocks in the detected uncovering areas. The combing module 106 then mixes the filtered motion vector results with the original motion vectors based on certain criteria. The mixed vectors are useful for video signal for video processing (MJC/FRC) 107.

Since the horizontal motion is more common than the vertical motion, the example below is directed to filtering out the outliers of motion vector in uncovering area caused by horizontal motion. However, the present invention is similarly applicable for motion in the vertical direction.

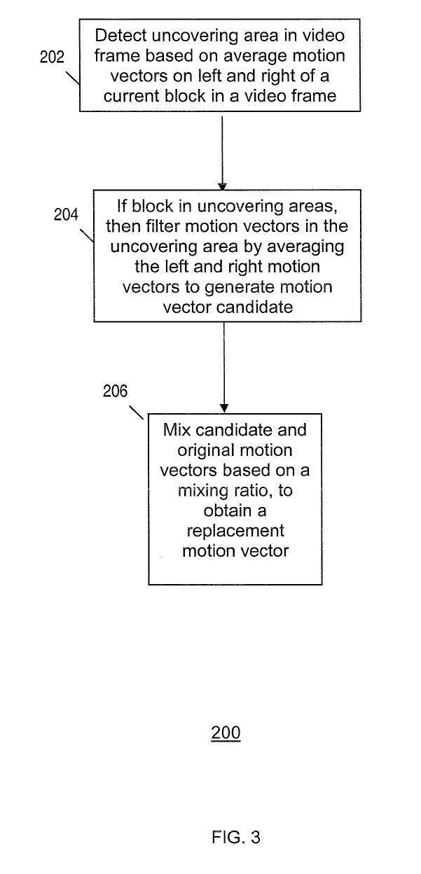

FIG. 3 shows a flowchart of a process 200, implemented by the system 100, described below. For detecting an uncovering area for a block in a current frame, the average horizontal motion vector on both left and right sides of the block are estimated; if the left side value is greater than the right side value, then the block is in an uncovering area (block 202).

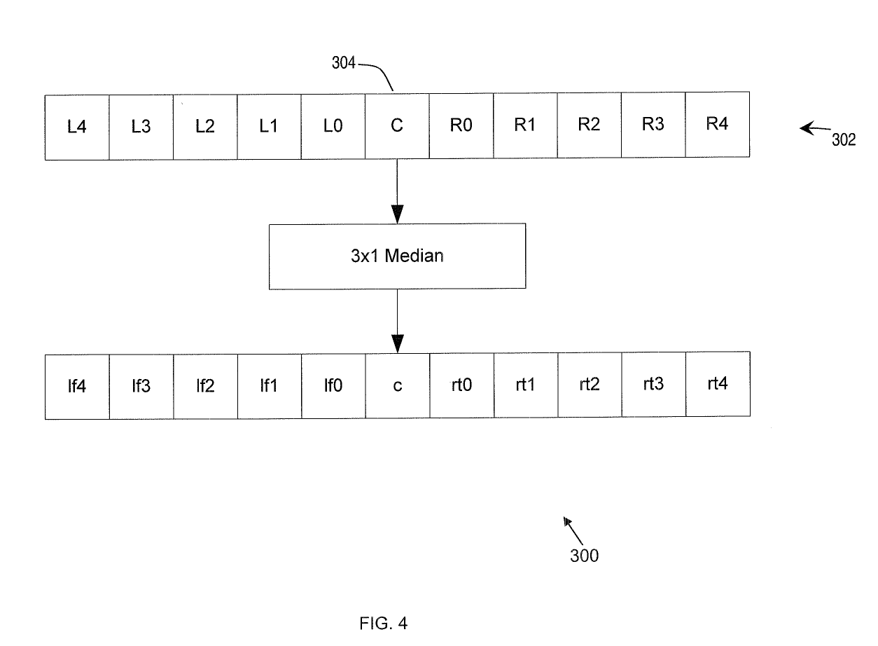

FIG. 4 shows an example 300 in which a line of motion vectors 302 (L4, L3, L3, L1, L0, C, R0, R1, R2, R3, R4) representing a motion field for a current frame is extracted. The motion vector C for a block of interest 304 is considered. A 3×1 median filter is first applied to all the motion vectors (L4, L3, L3, L1, L0, C, R0, R1, R2, R3, R4) to obtain a more smooth motion field (lf4, lf3, lf3, lf1, lf0, c, rt0, rt1, rt2, rt3, rt4). For example, the motion vector of block lf1 is the median of the motion vectors of blocks L0, L1, L2.

Then, the smoothness of the motion vectors is measured. In one implementation, measuring the smoothness s of MVs of certain blocks includes computing the standard deviation of the MVs of those blocks. If the standard deviation is less than a threshold T1, then the MVs are smooth, and s=1.0. If the standard deviation is greater than a threshold T2, then the MVs are not smooth, and s=0.0. If the standard deviation is between T1 and T2, then a ramp curve can be used to interpolate the smoothness value s.

In the above example, the smoothness of the motion vectors (lf4, lf3, lf3, lf1, lf0, c, rt0, rt1, rt2, rt3, rt4)) is denoted as:

1. s1 measures the smoothness of the motion vectors lf1, lf2, lf3.

2. s2 measures the smoothness of the motion vectors lf2, lf3, lf4.

3. s3 measures the smoothness of the horizontal MVs rt1, rt2, rt3.

4. s4 measures the smoothness of the motion vectors rt2, rt3, rt4.

If s1 is greater (smoother) than s2, the average of motion vectors lf1, lf2, lf3 is selected as the average motion vector MV_lf of the left side of block 204. Otherwise, the average of motion vectors lf2, lf3, lf4 is selected as MV_lf. If s3 is greater (smoother) than s4, the average of motion vectors rt1, rt2, rt3 is selected as the average motion vector MV_rt of the right side of block 204. Otherwise, the average of motion vectors rt2, rt3, rt4 is selected as MV_rt. If the average motion vector of the left side (MV_lf) is greater than the average motion vector of the right side (MV_rt), then block 204 is in an uncovering area of the video frame. As such, the motion vectors are filtered to eliminate erroneous motion filter for the block as an outlier in the motion field.

Filtering provides a motion vector candidate to replace a current motion vector if it is an outlier (block 204). In one example, the motion vector candidate (MV_candidate) is obtained by averaging said average motion vectors of both left and right sides, where MV_candidate 32 MV_avg=(MV_lf+MV_rt)/2.

The filtered motion vector MV_candidate is then combined (mixed) with the original (current) motion vector (block 206 ). To mix the filtered motion vector MV_candidate with the original (current) motion vector, in one example certain mixing criteria include four sub-ratios (r1, r2, r3, r4) that are computed as follows (for confirming that the original motion vector of the block 204 is an outlier).

The sub-ratio r1 is obtained based on the absolute difference of MV_lf and MV_rt. The larger the absolute difference, the wider the uncovering area. If the absolute difference is less than a preset threshold D1, then r1 is set to 0. If the absolute difference is greater than a preset threshold D2, then r1 is set to 1.0. If the absolute difference is between D1 and D2, then r1 can be linearly interpolated.

The sub-ratio r2 is obtained based on the smoothness of either right or left side of the block 204. By experiment, the inventors have determined that if the current (original) motion vector is an outlier, the motion vectors of at least one side of the current block 204 are smooth, such that, r2 is set to be the maximum value of s1, s2, s3, and s4.

To compute the sub-ratio r3, the minimum distance from the original motion vector to either MV_lf or MV_rt, is determined. If the original motion vector is an outlier, normally this distance is large. If the distance is less than a preset threshold C1, then r3 is set to 0. If the distance is greater than a preset threshold C2, then r3 is set to 1.0. If the distance is between C1 and C2, then r3 can be linearly interpolated.

The sub-ratio r4 is determined based on the direction of the original (current) motion vector. If the motion vector length of the original motion vector is closer to MV_lf than to MV_rt, then it is checked if the horizontal directions of original motion vector and MV_lf are the same. Otherwise, it is checked if the horizontal directions of original motion vector and MV_rt are the same. If they are the same, then r4 I set to 0. Otherwise r4 is set to 1.0.

Once r1 through r4 are determined, a final ratio is computed as r=r1*r2*r3*r4, wherein r represents the ratio of MV_candidate to be mixed with the original motion vector. An example of mixing/combination is: MV_out =MV_candidate*r+MV_orginal*(1−r).

The result is a replacement motion vector to be used in place of the current (original) motion vector for block 204, in such processes as FRC/MJC by reducing blockiness and halo in the output results. Only the motion vectors in the uncovering area are affected. Only an erroneous motion vector is corrected (i.e., filtered and mixed as above). This is more accurate and effective than a simple median filter.

For vertical motion, the left and right side calculations are replaced by above and below side calculations to obtain a vertical candidate as well. Then mixing can involve mixing vertical candidate with an original vertical vector based on a mixing ratio calculated in a similar fashion as above.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. Further, embodiments of the invention can take the form of an entirely hardware embodiment, an entirely software embodiment or an embodiment containing both hardware and software elements.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device.

The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read only memory (CD-ROM), compact disk-read/write (CD-R/W) and DVD.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Though the present invention has been described with reference to certain versions thereof, however, other versions are possible. Therefore, the spirit and scope of the appended claims should not be limited to the description of the preferred versions contained herein.

What is claimed is:

1. A method for detecting motion at a temporal intermediate position between image fields, comprising:
detecting an uncovering area in the temporal intermediate position in an image field;
determining a motion vector candidate, in place of a current original motion vector, for the temporal intermediate position with a detected uncovering area; and
determining a motion vector representing motion at the temporal intermediate position by combining the candidate motion vector with a current original motion vector for the temporal intermediate position.

2. The method of claim 1, wherein obtaining a motion vector representing motion at the temporal intermediate position further includes determining said current original motion vector, and combining the candidate motion vector with the current original motion vector.

3. The method of claim 1, wherein detecting an uncovering area in the temporal intermediate position in an image field, comprises:
estimating the average horizontal motion vector on both left and right sides of the temporal intermediate position in the image field; and
if the average motion vector of the left side is greater than the average motion vector of the right side, then the temporal intermediate position is an uncovering area.

4. The method of claim 3, wherein determining a motion vector candidate for the temporal intermediate position includes:
averaging said average motion vectors of both left and right sides of the temporal intermediate position to obtain the motion vector candidate.

5. The method of claim 3, wherein combining the candidate motion vector with the current original motion vector comprises:
combining the candidate motion vector with the current original motion vector based on the absolute difference of the average motion vector of the left side and the average motion vector of the right side.

6. The method of claim 3, wherein combining the candidate motion vector with the current original motion vector comprises:
combining the candidate motion vector with the current original motion vector based on the smoothness of either average motion vector of the right side or average motion vector of the left side.

7. The method of claim 3, wherein combining the candidate motion vector with the current original motion vector comprises combining the candidate motion vector with the current original motion vector based on the minimum distance from the original motion vector to the average motion vector of the right side and the average motion vector of the left side.

8. The method of claim 3, wherein combining the candidate motion vector with the current original motion vector comprises combining the candidate motion vector with the current original motion vector based the direction of the original motion vector relative to the average motion vector of the right side and/or the average motion vector of the left side.

9. An apparatus for detecting motion at a temporal intermediate position between image fields, comprising:
an area detector configured for detecting an uncovering area in the temporal intermediate position in an image field;
a filter configured for determining a motion vector candidate, in place of a current original motion vector, for the temporal intermediate position with a detected uncovering area; and
a combiner configured for determining a motion vector representing motion at the temporal intermediate position by combining the candidate motion vector with a current original motion vector for the temporal intermediate position.

10. The apparatus of claim 9, wherein the combiner is further configured for determining said current original motion vector, and combining the candidate motion vector with the current original motion vector.

11. The apparatus of claim 9, wherein the area detector is further configured for estimating the average horizontal motion vector on both left and right sides of the temporal intermediate position in the image field, such that if the average motion vector of the left side is greater than the average motion vector of the right side, then the temporal intermediate position is an uncovering area.

12. The apparatus of claim 11, wherein the filter is further configured for determining a motion vector candidate for the temporal intermediate position by averaging said average motion vectors of both left and right sides of the temporal intermediate position to obtain the motion vector candidate.

13. The apparatus of claim 11, wherein the combiner is further configured for combining the candidate motion vector with the current original motion vector based on the absolute difference of the average motion vector of the left side and the average motion vector of the right side.

14. The apparatus of claim 11, wherein the combiner is further configured for combining the candidate motion vector with the current original motion vector based on the smoothness of either average motion vector of the right side or average motion vector of the left side.

15. The apparatus of claim 11, wherein the combiner is further configured for combining the candidate motion vector with the current original motion vector based on the minimum distance from the original motion vector to the average motion vector of the right side and the average motion vector of the left side.

16. The apparatus of claim 11, wherein the combiner is further configured for combining the candidate motion vector with the current original motion vector based on the direction of the original motion vector relative to the average motion vector of the right side and/or the average motion vector of the left side.

17. A video processing system, comprising:
a detection module configured for detecting motion at a temporal intermediate position between image fields, including:
an area detector configured for detecting an uncovering area in the temporal intermediate position in an image field;
a filter configured for determining a motion vector candidate, in place of a current original motion vector, for the temporal intermediate position with a detected uncovering area;
a combiner configured for determining a motion vector representing motion at the temporal intermediate position by combining the candidate motion vector with a current original motion vector for the temporal intermediate position; and
a motion compensation module configured for frame rate conversion (FRC) and/or motion judder cancellation (MJC) using the combined vectors.
